(19) United States
(12) Patent Application Publication
(10) Pub. No.: US 2008/0018917 A1
(43) Pub. Date: Jan. 24, 2008

(54) DOCUMENT EDITING SYSTEMS AND METHODS

(75) Inventor: Xiao-Qiu Zhang, Suzhou (CN)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/757,300

(22) Filed: Jun. 1, 2007

(30) Foreign Application Priority Data
Jul. 19, 2006 (TW) TW95126359

(51) Int. Cl. G06F 15/00

(52) U.S. Cl. 358/1.5

(57) ABSTRACT

A document editing system and method are disclosed. A driver for driving a printing device receives a print job corresponding to a document processed by an application. During display of a print preview of the print job, a selection tool for selecting a portion of the print preview is displayed. An editor modifies the portion of the print preview selected by the selection tool and generates a second print job according to the modified print preview. The driver drives the printing device to execute the second print job.

### BACKGROUND OF THE INVENTION

1. Field of the Invention

The invention relates to computer techniques, and more particularly to document authoring.

2. Description of the Related Art

FIG. 1A shows the configuration of a system for authoring and printing text documents, forms, or graphics, comprising application 110, graphics subsystem 120, driver 130, and printer 140. Examples of document editing applications comprise Microsoft Word, Excel, PowerPoint, Note, Paint, and others. Examples of graphics subsystems comprise Windows graphics device interface (GDI) or Apple QuickDraw.

In a document printing system, an application edits a document comprising text, graphics, and bitmaps. When receiving a document print command, the application allocates a print job to an operating system (OS). A graphics subsystem of the OS invokes a printer driver to begin the document print job.

A print preview function, accessed via user operation, displays a virtual representation of the document including text and graphics layout. If it is determined that the document requires further changes during print preview, the changes are made to the original document file, rather than the print preview, thus layout and content of the original file is modified.

For example, a user may wish to delete a paragraph via a word processing application. The deleted paragraph is replaced with the following content, thus the change document layout is changed. If the change is saved in the original document, the paragraph is substantially removed therefrom. To remove the paragraph from the original document file to keep it from being printed or displayed by the print preview function, the print preview must first be closed. The paragraph is then deleted, the modified document saved and finally the document is printed. Thus the conventional method is inconvenient and time consuming.

Additionally, a word processing application may not support detailed image authoring functions for remove a graphic or an image from a print job during print preview.

As can be deduced from the foregoing, it is difficult to modify a document without changing the original document file layout.

### BRIEF SUMMARY OF THE INVENTION

A document editing system is provided. An exemplary embodiment of a document editing system comprises a selection tool and an editor. When a driver for driving a printing device receives a print job corresponding to a document processed by an application, a preview module displays a print preview of the print job. The selection tool selects a portion of the print preview. The editor modifies the portion of the print preview selected by the selection tool and generates a second print job according to the modified print preview, such that the driver drives the printing device to execute the second print job.

A document editing method is provided. An exemplary embodiment of a document editing method comprises the following steps. When an application initiates a document print job, a driver for driving a printing device receives the print job. A selection tool selects a portion of the document during print preview. An editor modifies the selected portion of the previewed document. A second print job is generated according to the modified print preview. The printing device executes the second print job.

Another embodiment of a document editing method comprises the following steps. When an application opens a document, a selection tool selects a portion of the document. Document content substituting for the selected portion of the document is automatically generated according to the position and dimensions of the selected portion. The selected portion is replaced by the generated document content.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1A is a block diagram of the configuration of a conventional printer system;

FIG. 1B is a schematic view showing the configuration of a document authoring system and a document printing system;

FIG. 2 is a schematic view showing an exemplary embodiment of a computer system comprising a document authoring system;

FIG. 3 is a flowchart showing operations of a print control system implementing the document authoring system;

FIG. 4A is a schematic view showing a print preview of an invoice including a stamp;

FIG. 4B is a schematic view showing a print preview of the invoice with the stamp cleared;

FIG. 5 is a flowchart showing an exemplary embodiment of print preview editing;

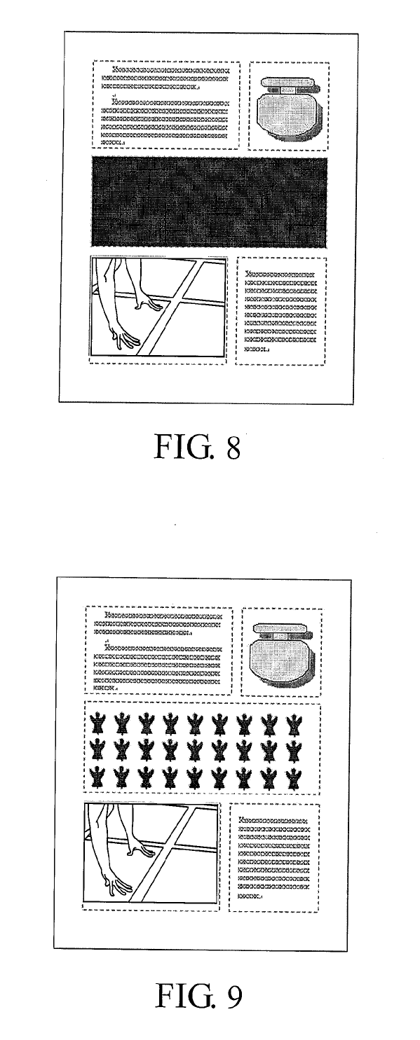

FIG. 6 is a schematic view showing an example of a print preview;

FIG. 7 is a schematic view showing the print preview in FIG. 6 with an area therein removed;

FIG. 8 is a schematic view showing the print preview in FIG. 6 with an area therein filled with a selected color;

FIG. 9 is a schematic view showing the print preview in FIG. 6 with an area therein filled with a selected pattern;

FIG. 10 is a flowchart showing an exemplary embodiment of a document authoring method; and

FIGS. 11A˜11E are examples of a document.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The following description is organized in the following sections. The configuration of a document authoring system applied in a print control system. The operational flowchart of a document authoring system applied in a print control system, and an exemplary embodiment of print preview authoring.

The Configuration of a Document Authoring System Applied in a Print Control System

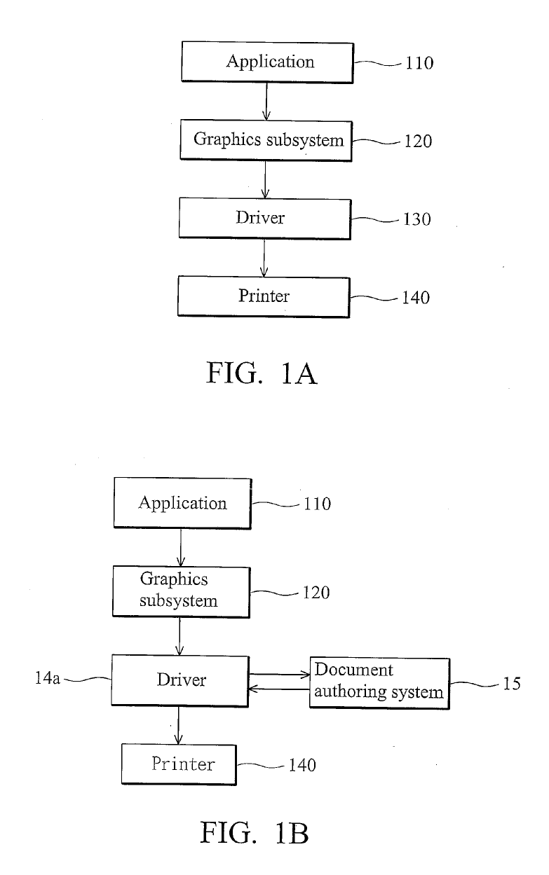

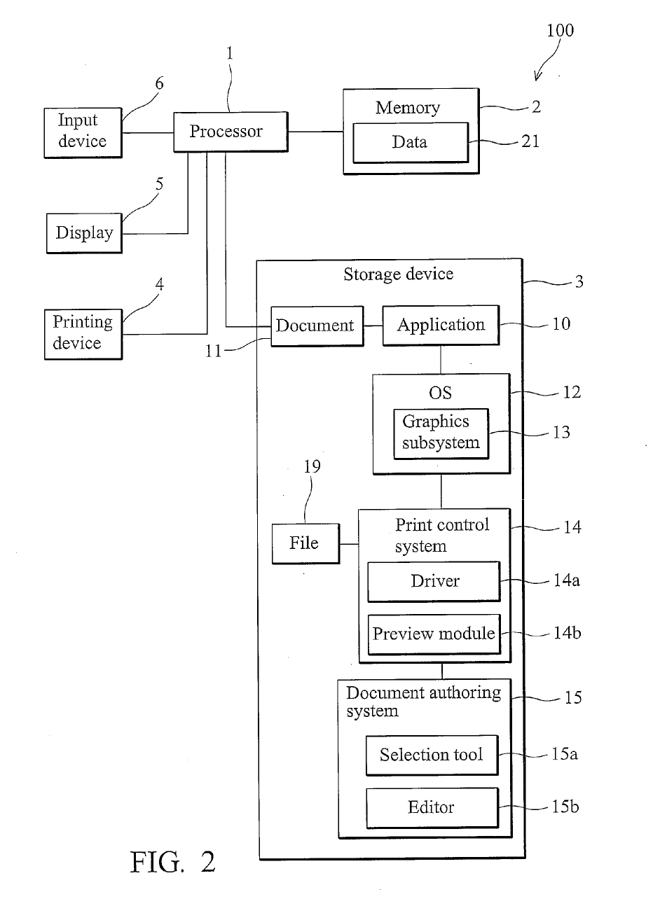

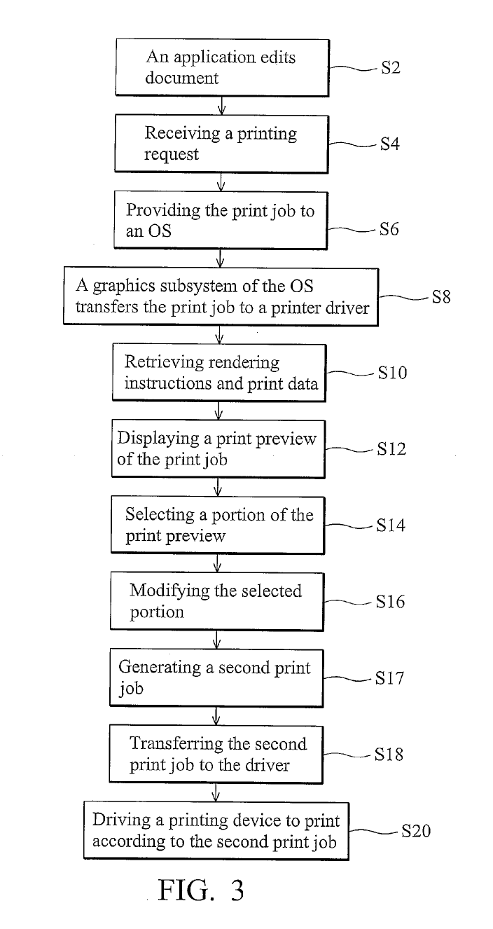

FIG. 1B shows the configuration of a document authoring system and a document printing system. With reference to FIG. 2, a computer system 100 comprises processor 1, memory 2, storage device 3, printing device 4, display 5, and input device 6. Storage device 3 stores operating system (OS) 12, application 10, print control system 14, and document authoring system 15 of computer system 100. The processor may load any of the OS 12, application 10, print control system 14, and document authoring system 15 to memory 2 to be executed. Storage device 3 may comprise a hard disk drive or other non-volatile memory, such as flash memory. Printing device 4 may comprise a printer, a multifunction machine, a photostat, or any other output device. Input device 6 may comprise a keyboard, a mouse, a touch panel, or any other input device.

Print control system 14 comprises driver 14a and preview module 14b. Driver 14a controls printing device 4. Preview module 14b displays a document print job preview prior to printing. Document authoring system 15 comprises selection tool 15a and editor 15b. Selection tool 15a selects a portion of a document for further modification while a document is displayed by preview module 14b. Selection tool 15a may select text, graphics, images, image areas or pixels in the previewed document. Editor 15b authors an area of the document selected by selection tool 15a, such as filling the selected area of the document with a specific color or a pattern. Note that even though document authoring system 15 is applied to print control system 14 in the exemplary embodiment, a document authoring system may be applied to any environment for document authoring.

Document Authoring System 15 Workflow Applied in Print Control System 14

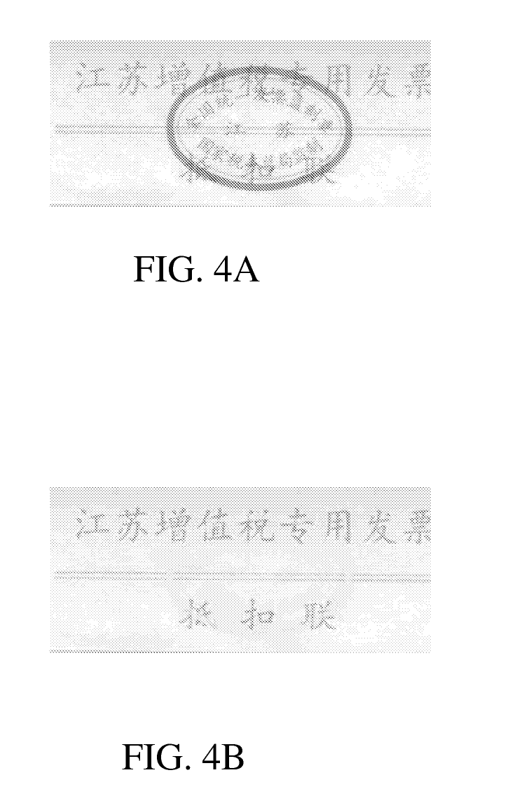

With reference to FIG. 3, application 10 edits document 11 which may comprise text, graphics, and bitmaps (step S2). When receiving a request for printing the document from a user (step S4), application 10 provides a print job to OS 12 (step S6), graphics subsystem 13 of OS 12 receives and transfers the print job to driver 15a (step S8). The print job may comprise image rendering instructions and print data (comprising text, graphics, and bitmaps in document 11). Driver 14a converts instructions and data in the print job into data 21 recognizable by printing device 4 and stores data 21 in memory 2. Data 21 may be stored in any other device in computer system 100.

Preview module 14b retrieves and analyzes instructions and print data 21 (step S10) and displays a print preview of the print job (step S12).

Selection tool 15a selects a portion of the print preview as modification target (step S14). Selection tool 15a may select pixels in a color range or in an area of the print preview.

For example, when selecting pixels in a color range, selection tool 15a may provide an interface for setting respective ranges for each color in a color system, such as respective ranges for red, green, and blue (RGB) in primary colors to constitute the color range. Selection tool 15a selects pixels of the print preview in the color range as a selected portion.

Ranges for each color may be entered through input device 6 or automatically generated based on a color basis selected by selection tool 15a. For example, an addition or subtraction operation is applied on the base color to generate the color range.

Selection tool 15a may select pixels in an image area of the print preview. For example, various shapes, such as a rectangle, a triangle, or others may be utilized to select an area. Selection tool 15a may generate an enclosed area based on track of a cursor of a mouse or a touch panel and select pixels in the enclosed area as the selected portion.

Selection tool 15a directly selects a portion of the print preview for further authoring by editor 15b (step S16), such modification of colors, shapes, texture, position, and other attributes while leaving unselected areas of the print preview unchanged. Editor 15b may delete the selected portion, or fill the selected portion with a specific color or a pattern. For example, when deleting the selected portion, editor 15b may fill the selected portion with a white color, thus preventing printing device 4 from outputting ink to the selected portion. Editor 15b may provide a list of colors to be selected and utilized to fill the selected portion. Editor 15b may provide a list of patterns to be selected and utilized to fill the selected portion. Editor 15b may enter text or images in a selected portion. Note that selection tool 15a and editor 15b may provide other tools for editing any area of previewed document.

Editor 15b generates a second print job based on the modified print preview. The second print job integrates the first print job and the modification made by editor 15b. The modification in the second print job comprises the coordinates and modified content of the selected portion. Editor 15b generates a second print job based on the modified print preview (step S17) and transfers the second print job to driver 14a (step S18) which further drives printing device 4 to print according to the second print job (step S20), thus printed material conforms to the modified print preview, thus the previewed document will be reproduced exactly when printed.

Editor 15b may provide options for storing the coordinates and modified content of the selected portion to another file 19. Note that file 19 and document 11 are separated from each other and may comprise different files in different formats. When a third print job is delivered to print document 11, editor 15b may load file 19 to integrate the modification to print preview of document 11 and keep relative positions and proportional dimensions of the modified portion and the print preview.

For example, editor 15b may store the modified portion and the modified content therein as vector images and store a position of the vector image with reference to a position of the background, text, graphics, bitmap, or any other object of document 11 and keep relative positions and proportional dimensions of the modified portion and the print preview for each integration thereof. When the modification is integrated with a print preview of document 11, editor 15b generates a print job of the integrated document and outputs the print job to printing device 4 for printing.

As appreciated from the previous description, editor 15b can edit a document in the print preview thereof without changing the layout of the original document.

Additionally, editor 15b may store the modified print preview as an additional document without changing the content and layout of the original document. The modified print preview, however, may replace the original document file.

An example of print preview authoring is provided in the following.

An Example of Print Preview Authoring:

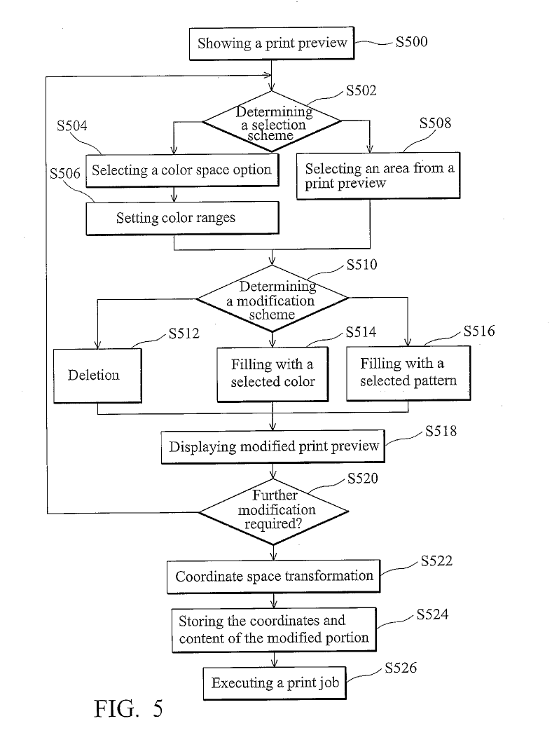

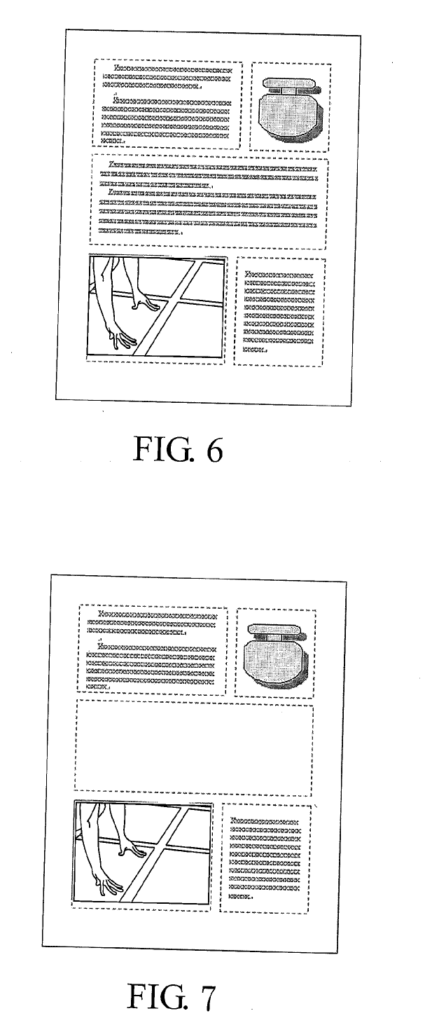

The method may be applied to various fields. For example, in the tax field, the method may remove stamps on an invoice when copying the same invoice. FIG. 4A shows a schematic diagram of an invoice with a red stamp. The red stamp exists on an invoice image in a document. When a document print job is initiated, the invoice is shown in a print preview of the document, and the red stamp in the invoice may be removed by selecting a color range of the red stamp, and filling the area of the red stamp with the background color of the invoice, the result of which is shown in FIG. 4B. An example of print preview authoring is provided in the following.

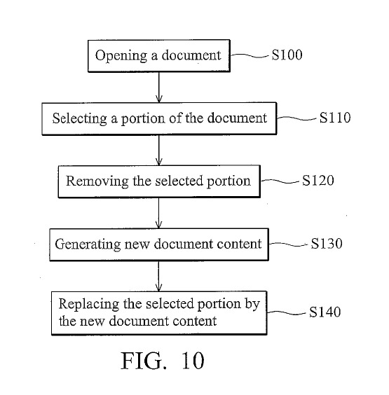

When preview module 14b shows a print preview (such as a print preview in FIG. 6) (step S500), one of a plurality of selection schemes, such as a selection module, provided by editor 15b is determined (step S502). If a selection module for selecting a color range is determined, selection tool 15a provides various color space options (such as Lab, RGB, HSB color systems). When a color space option is selected (step S504), selection tool 15a displays a configuration interface for setting color ranges for respective primary colors in the selected color space. The configuration interface is utilized to define color ranges for selection of a portion in a print preview (step S506). For example, the configuration interface is utilized to define a range of red color for selection of the red stamp in FIG. 4A. When a selection module for selecting an image area is determined, the selection module is utilized to select an area from a print preview in various shapes (step S508).

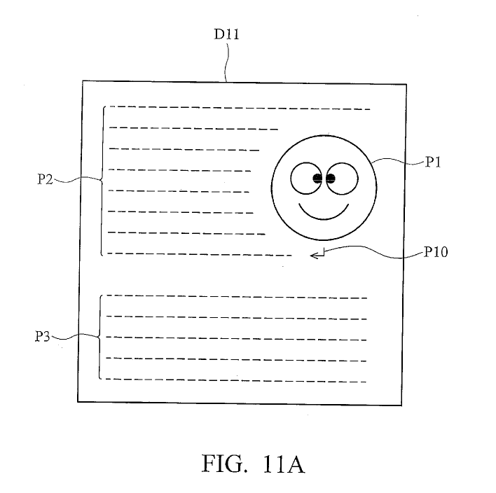

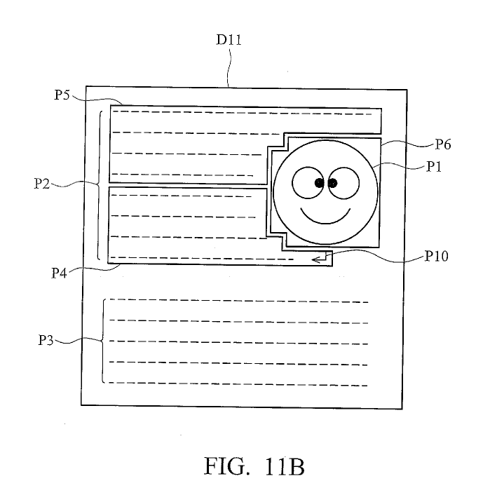

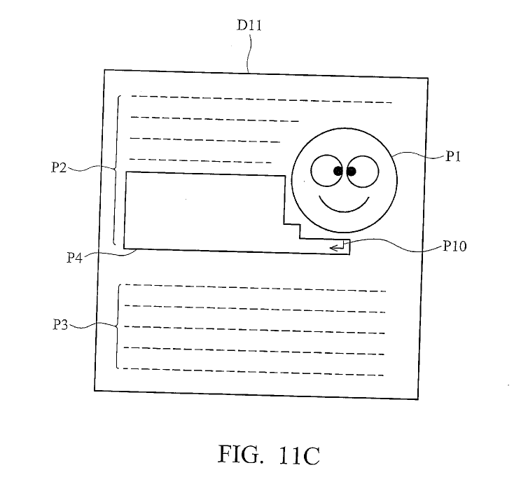

A modification scheme is determined (step S510). Editor 15b may display edit tools for editing print previews. When a delete option is selected, the selected portion is filled with the background color of the document or a white color the RGB value of which is (255, 255, 255) (step S512). Editor 15b may automatically detect or retrieve a sample of the background color of the document. Preview module 14b displays modified print preview (step S518). FIG. 7 shows the result of removing an area of the image in FIG. 6. When a color fill option is selected, the selected portion is filled with a selected color (step S514). FIG. 8 shows the result of filling an area of the image in FIG. 6 with a selected color. When a pattern fill option is selected, the selected portion is filled with a selected pattern (step S516). FIG. 9 shows the result of filling an area of the image in FIG. 6 with a selected pattern.

It is determined whether to perform a further modification (step S520). If so, step S502 is repeated. If not, coordinates in the modified print preview are transformed from one coordinate space to another coordinate space (step S522). The coordinates and modified content of the selected portion is stored (step S524). A print job is executed based on the modified print preview (step S526). When another document print job is to be performed, editor 15b may integrate the modified content to the document to be printed.

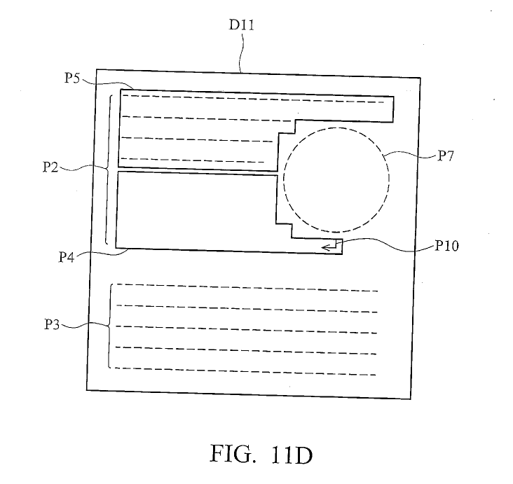

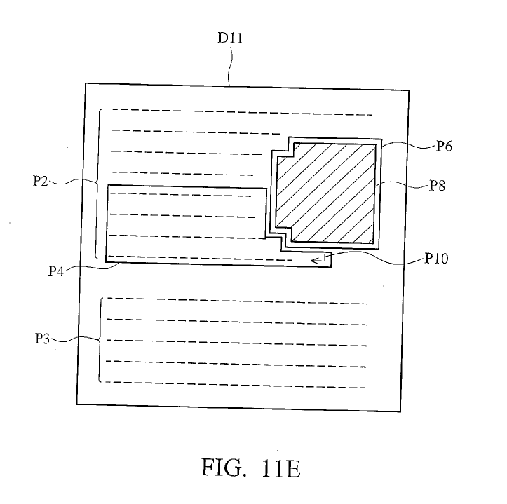

Additionally, when an application opens a document, the application may provide a document editing function for directly modifying documents the same as those applied in print previews regardless of whether the document is to be printed. For example, when the selected portion is removed from the document, new document content is automatically filled into the selected portion, thus the layout of the unselected portion of the document is the same. The target to be removed may first be selected by a selection tool before removal or directly removed by a delete key to prevent changes to the layout of the unselected portion of the document. The editing function may be provided by a plug-in of the application. The document editing function is described with reference to FIG. 10 and FIGS. 11A˜11E. Document D11 in FIG. 11A comprises paragraphs P2 and P3. In FIG. 11B, paragraph P2 comprises text regions P4 and P5, image P1, and line change symbol P10.

When an application (such as application 10) opens a document (such as document D11 in FIG. 11A) (step S100), a selection selects a portion of the document (such as text region P4 in FIG. 11B) (step S110), for example, utilizing a cursor to select text or an image.

When the selected portion is to be removed from the document (such as removing text region P4 in FIG. 11B) (step S120), an editor generates new document content according to the position and dimensions of the selected portion (step S130) and replaces the selected portion by the new document content (step S140), thus preventing changes to the layout of document components (such as paragraph P3, text region P5, and image P1 in FIG. 11B) other than the selected portion. The new document content comprises space characters (including space, tab, and enter symbols) or images (such as color objects or patterns in vector image or bitmap format). The selected portion of the document may be removed at or before step S140, and the new document content is placed on the original position of the selected portion. The position and dimensions of the new document content is identical to those of the selected portion.

For example, the application generates space characters to fill region P4 in FIG. 11B, thus keeping the position of line change symbol P10 the same and paragraph P3 from moving upward, as shown in FIG. 11C. Alternatively, as shown in FIG. 11D, when image P1 is deleted, the application generates image P7 which may be transparent or comprise the background color of the document without changing the layout of text regions P4 and P5. With reference to FIG. 11E, image P1 may be replaced by image P8 of various shapes, or space characters without changing the layout of text regions P4 and P5.

The application may display an interface providing the space characters, color objects, or patterns to be selected as the new document content. The new document content may be predetermined or selected on the fly. For example, the application displays a plurality of control units (such as buttons, combination keys, or other user interfaces) representing the new document content (such as space characters and images). When a region of the document is selected, the application automatically deletes the selected region and performs the replacement in response to activation of a control unit by a user rather than in response to a depressed delete button.

The selection function may be taken via a cursor or a selection tool of the application. The application may automatically delete the selected region and perform the replacement in response to selection of the region.

The application may be switched to a document editing mode, in which editing may not affect the original document file. In the document editing mode, any modified document may be restricted to being saved as another file rather than the original document. Alternatively, modifying a document in document editing mode may be canceled when the document editing mode is disabled, thus the document is able to recover its previous status. In addition to these schemes, the application may disable automatic word processing functions thereof.

As appreciated from the description, a conventional print control system cannot edit print preview, and must return to a document processing application to modify an original document, such as removing confidential data or trademarks. As integrated in a print system, the document authoring method and system of the invention allows direct modification of print previews and accordingly drives a printing device. Additionally, modifications to an original document may be saved external to the document, thus document layout and content changes are prevented.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A document editing system, wherein when a driver for driving a printing device receives a print job corresponding to a document processed by an application, a preview module displays a print preview of the print job, comprising:
a selection tool for selecting a portion of the print preview; and
an editor modifying the portion of the print preview selected by the selection tool and generating a second print job according to the modified print preview, such that the driver drives the printing device to execute the second print job.

2. The system as claimed in claim 1, wherein the selection tool selects pixels in a color range from the print preview, and the selected portion comprises the selected pixels.

3. The system as claimed in claim 1, wherein the selection tool selects pixels in an area of the print preview, and the selected portion comprises the selected pixels.

4. The system as claimed in claim 1, wherein the editor fills the selected portion of the print preview with a specific color.

5. The system as claimed in claim 1, wherein the editor fills the selected portion of the print preview with a specific pattern.

6. The system as claimed in claim 1, the editor stores the modified portion of the print preview in addition to the document, when a third document print job is executed, the portion is associated with the document to perform the third print job.

7. The system as claimed in claim 6, wherein the editor utilizes a position of an object in the print preview as a reference position for storage of the modified portion.

8. The system as claimed in claim 7, wherein the editor stores proportion of the dimensions of the document and the modified portion.

9. A document editing method, comprising:
when an application initiates a document print job, reception of the print job by a driver for driving a printing device;
when a print preview of the print job is displayed, a selection tool selects a portion of the print preview;
modification of the selected portion of the print preview by an editor;
generating a second print job according to the modified print preview; and
driving of the printing device by the driver to execute the second print job.

10. The method as claimed in claim 9, wherein the selection tool selects pixels in a color range from the print preview, and the selected portion comprises the selected pixels.

11. The method as claimed in claim 9, wherein the selection tool selects pixels in an area of the print preview, and the selected portion comprises the selected pixels.

12. The method as claimed in claim 9, further comprising utilizing the editor to fill the selected portion of the print preview with a specific color.

13. The method as claimed in claim 9, further comprising utilizing the editor to fill the selected portion of the print preview with a specific pattern.

14. The method as claimed in claim 9, further comprising:
storing the modified portion of the print preview in addition to the document; and
when a third document print job is executed, the modified portion is associated with the document to perform the third print job.

15. The method as claimed in claim 14, further comprising utilizing a position of an object in the print preview as a reference position for storage of the modified portion.

16. The method as claimed in claim 15, further comprising storing a proportion of the dimensions of the document and the modified portion.

17. A document editing method, comprising:
when an application opens a document, selection of a portion of the document by a selection tool; and
automatically generating document content in substitution for the selected portion of the document according to the position and dimensions of the selected portion, and replacing the selected portion by the generated document content.

18. The method as claimed in claim 17, further comprising automatically executing the replacement step in response to deletion of the selected portion from the document.

19. The method as claimed in claim 17, further comprising automatically executing the replacement step in response to selection of the portion of the document.

20. The method as claimed in claim 17, wherein the generated document content comprises a space character, a color, or a pattern.
